(19) United States
(12) Patent Application Publication
(10) Pub. No.: US 2003/0178238 A1
(43) Pub. Date: Sep. 25, 2003

(54) Sliding Safety Bumper

(76) Inventor: Primitivo F. Ruiz, Clackamas, OR (US)

Correspondence Address: Primitivo F. Ruiz, P.O. Box 2134, Clackamas, OR, 97015, US

(21) Appl. No.: 10/103,270

(22) Filed: Mar. 22, 2002

(51) Int. Cl. B60R 19/00

(52) U.S. Cl. 180/274

(57) ABSTRACT

The SLIDING SAFETY BUMPER consists of two (2) U shaped steel channels that contain steel springs, each enclosed in a triple sliding sleeve, a synthetic rubber cushion bonded to one (1) of the U shaped channels. The other U shaped steel channel attaches the bumper to the frame of the vehicle. The bumper also contains a hydraulic system that transmits impact force to a master cylinder in severe impacts. The space between the channels is covered with an accordian folding plastic. The SLIDING SAFETY BUMPER is attached to both the front and rear of the vehicle.

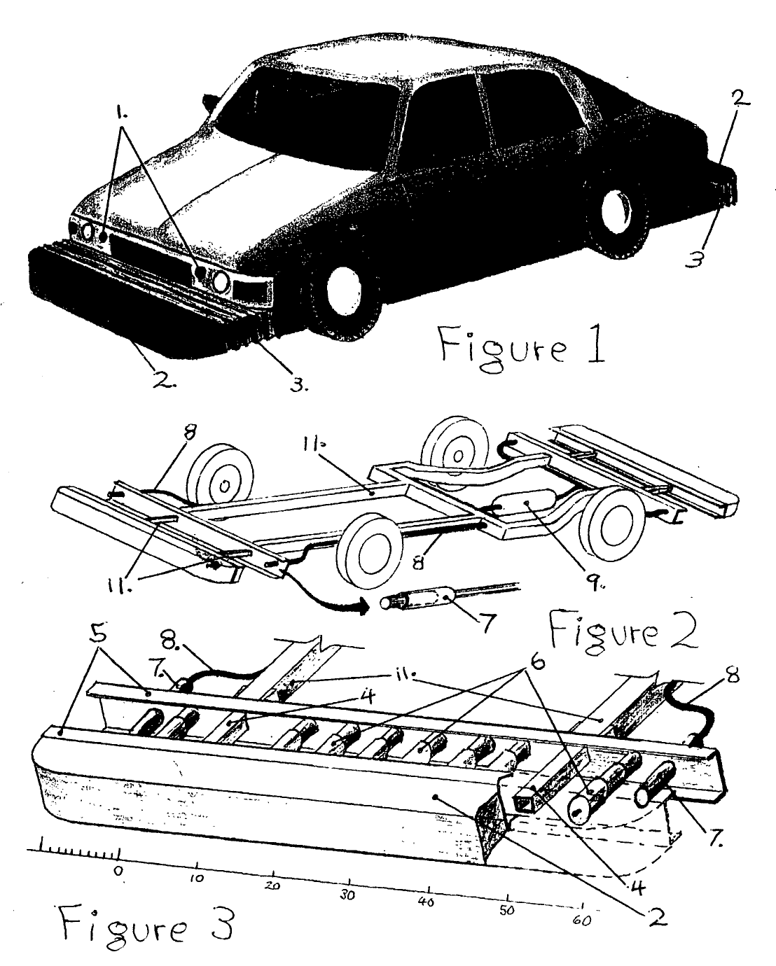

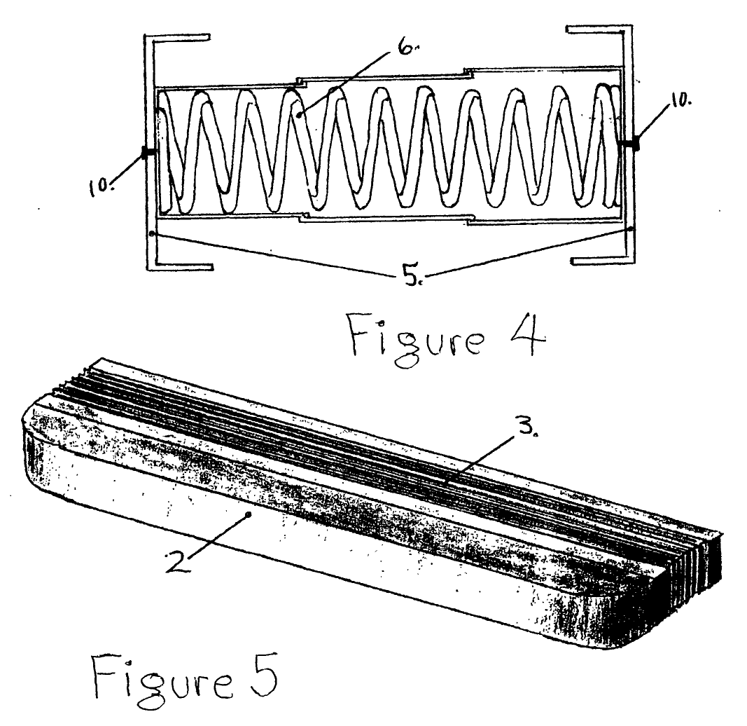

OPTIONAL For additional protection a two (2) inch layer of shock absorbing plastic can be applied to the inside of the vehicle.

### HISTORY AND BACKGROUND

Every year thousands of people are injured or killed as a result of their vehicle coming to an abrupt stop. If this could be reduced, even only a little, many lives could be spared or escape with minor injury. Even a small impact can cost hundreds of dollars to repair. A device or system that could prevent or reduce such damage would be of inestimatable value. It is my goal to help prevent some of this carnage.

I made a search beginning with the year 1976 through Feb. 14, 2002. This search revealed 185 patents having to do with automobile safety. Only four (4) of these have to do with a bumper. NONE of the patents have any resemblence to the SLIDING SAFETY BUMPER for which I seek a patent.

### SUMMARY

The SLIDING SAFETY BUMPER is a SYSTEM to prevent damage to a vehicle in slight impacts with a solid object or another vehicle and to add to the safety of the occupants of a vehicle in a severe impact.

1) Purpose

A) Prevent damage to a vehicle in slight impacts from the front or from the rear.

B) Add to the safety of the occupants of a vehicle in a severe impact from the front or from the rear.

C) Prevent a vehicle from following too close in moving traffic.

2 Description

A) Electric Eye to signal the engine to reduce fuel intake causing the vehicle to slow down when vehicle is traveling at speeds in excess of 30 mph and is within five (5) feet of the vehicle in front.

B) The front edge of the front bumper and the rear edge of the rear bumper has a synthetic rubber cushion at least six (6) inches thick, bonded to a U shaped steel channel.

C) Steel Springs (8 in the front bumper and 8 in the rear bumper) enclosed in a triple sliding metal sleeve that is positioned between two (2) U shaped steel channels.

D) Hydraulic Piston (2 in front and 2 in the rear) to go into action only in severe impacts to transmit impact force to a master cylinder.

E) The bumper, both front and rear, are to be enclosed in an accordian folding plastic cover.

3) Variations

A) The size and capacity of the springs can be adjusted to resist the anticipated force of an impact.

B) The thickness and resiliance of the synthetic rubber cushion can be adjusted to cushion the anticipated force of an impact. The cushion must be at least six (6) inches thick as measured from front to rear.

C) The Master Cylinder can be located where most convient.

D) The color of the accordian folding plastic is to be such as to compliment the decor of the vehicle.

3) Optional

For additional protection, two (2) inch layer of shock absorbing plastic can be applied to the inside of the vehicle.

### DETAILED DESCRIPTION

This is a SYSTEM to protect a vehicle from damage in mild impacts from front or rear and to give occupants a better chance to survive a serious impact, front or rear. This protection is to occur in steps.

Step 1—Electric eye to signal engine to reduce fuel intake when vehicle is moving in excess of 30 mph and is five (5) feet or less from an abstacle such as a bridge abutment or another vehicle.

Step 2—Initial impact to be absorbed by the resilience of the synthetic rubber cushion, which is at least six (6) inches thick as measured from front to rear, and is bonded to front of the front channel and to the rear of the rear channel of the rear bumper.

Step 3—An impact too severe to be absorbed by the ‘cushion’ is further absorbed by eight (8) springs, each enclosed in a triple sliding sleeve to protect the springs from road crime and water as well as to attach the springs to the bumper assembly. The triple sliding sleeves are attached by means of two (2) bolts, one at each end. The bumper consists of two (2) U shaped steel channels. The channel facing the traffic has a synthetic cushion bonded to the U shaped channel. The second U shaped channel attaches the bumper to the vehicle. The front U shaped channel (i.e. the one facing the traffic) is able to slide be cause it is welded or otherwise securely attached to two (2) rectangular channels that slide into the hollow frame of the vehicle.

Step 4—In a severe impact the U shaped channel that attaches the bumper assembly to the vehicle contains two (2) hydraulic pistons, which are set back several inches from the U shaped channel that is bonded to the cushion so as to have no effect except in severe impacts, which transmit impact force to a master cylinder. The master cylinder is partially filled with hydraulic fluid. The small remaining space is filled with compressed air. This is to be a closed system (i.e. not added or removed). The hyudraulic pistons are connected to the master cylinder by steel tubing.

Step 5—OPTIONAL—Two (2) inches of shock absorbing plastic on the inside of the vehicle.

The bumper describe above is attached to both the front and rear of the vehicle.

The space between channels is enclosed by an accordian folding plastic cover. The cover is mainly for esthetic purpose. The accordian fold allows the cover to return to its original shape in mild impacts.

### Key to Drawings

1. Electric eye

2. Synthetic Rubber Impact Cushion

3. Accordian Folding Plastic Cover

4. Rectangular Channel to Support Bumper

5. U Shaped channel to contain and/or attach to frame of the automobile or to support Impact Cushion.

6. Triple sleeved enclosed Springs (16-8 in front bumper and 8 in rear bumper)

7. Hydraulic Piston

8. Steel hydraulic lines

9. Master Cylinder

10. Bolt to attach the Triple Sleeve to the U channel

11. Frame of the Automobile

1. I claim that the SLIDING SAFETY BUMPER will prevent to a vehicle in minor impacts and provide additional protection to the occupants to prevent the loss of life in serious impacts and serious injury in moderate impacts. The electric eye will prevent or reduce rear end collisions by reducing fuel intake to the engine.
I further claim that addition of the SLIDING SAFETY BUMPER will enhance the appearence of an automobile and it's sales value.
I further claim that as an option a two (2) inch layer of shock absorbing plastic applied to the inside will increase the safety if the occupants.
